(19) United States
(12) Patent Application Publication
(10) Pub. No.: US 2025/0231396 A1
(43) Pub. Date: Jul. 17, 2025

(54) DEVICE FOR PROCESSING AT LEAST TWO SINGLE-MODE LIGHT BEAMS

(71) Applicant: CaILabs, Rennes (FR)

(72) Inventors: Antonin Billaud; Olivier Pinel, Rennes (FR); Guillaume Labroille, Rennes (FR)

(21) Appl. No.: 18/702,678

(22) PCT Filed: Oct. 17, 2022
(86) PCT No.: PCT/FR2022/051958

§ 371 Date: Apr. 18, 2024

(30) Foreign Application Priority Data
Oct. 28, 2021 (FR) 2111490

(51) Int. Cl. G02B 26/06; G02B 27/10; H04B 10/11

(52) U.S. Cl. CPC G02B 26/06; G02B 27/1013; H04B 10/11

(57) ABSTRACT

A device for processing at least two incident beams having variable phases and/or amplitudes comprises at least the following elements connected to each other in succession by free spaces or by waveguides: a first phase actuator circuit for adjusting the phases of the incident beams; a multi-plane conversion device; and a second phase actuator circuit arranged downstream of the multi-plane conversion device. An optical system may employ such a processing device to recombine the incident beams into a recombined light beam.

### CROSS REFERENCE TO RELATED APPLICATIONS

This application is a national phase entry under 35 U.S.C. § 371 of International Patent Application PCT/FR2022/051958, filed Oct. 17, 2022, designating the United States of America and published as International Patent Publication WO 2023/073301 A1 on May 4, 2023, which claims the benefit under Article 8 of the Patent Cooperation Treaty to French Patent Application Serial No. FR2111490, filed Oct. 28, 2021.

### TECHNICAL FIELD

The present disclosure relates to a device for processing at least two single-mode and coherent light beams, for example, with a view to recombining them. This device can find numerous applications, and, in particular, for compensating for the distortion of the wavefront of light radiation. This distortion may originate in atmospheric disturbances during an optical communication in free space. More generally, this distortion may be caused by the propagation of the light radiation in its medium. Embodiments of the present disclosure can find an application in the field of telecommunications or in the shaping of parts by laser.

### BACKGROUND

In the field of optics, it is sometimes sought to combine a plurality of single-mode and coherent light beams to form a single beam having, for example, an increased energy density, a chosen shape or point. This combination can be carried out by multiple means, for example, using a diffractive grating as taught in document WO2007100752, using a photonic device as proposed by document US20090220246, or using a multiplane light conversion device (as offered by the product “TILBA” from the company Cailabs or in document WO2020161126). In every case, the optical quality of the combined beam is very dependent on the phase matching and the amplitude equality of the incident light beams.

However, these beams have properties that are not always perfectly controlled or directly controllable. For example, these beams may result from the modal decomposition of incident light radiation after propagation of this radiation in a medium (atmosphere, fiber, etc.). This propagation can cause significant distortion of the radiation, and the beams that decompose it according to modality then have phase and amplitude variations between them, also variable over time.

When the beams to be recombined are not perfectly controlled in phase or amplitude, the transformation carried out by known coherent combining devices is not perfectly controlled, which may lead to deterioration of the quality or the power of the combined beam. A portion of the energy present in the incident beams is indeed in this case absorbed, scattered or diffracted by the combination device and the combined beam is then not spatially concentrated. It may thus have low amplitude radiation combined with a diffuse halo.

In general, it would be useful to be able to have a device making it possible to regularize the relative phases and amplitudes of a plurality of light beams whose characteristics are not perfectly controlled, in order to make the subsequent robust manipulations on these beams.

### BRIEF SUMMARY

One aim of the present disclosure is to propose such a device for processing at least two single-mode light beams. Another aim of the present disclosure is to propose an optical system, benefiting from this device, in particular, in order to recombine at least two single-mode light beams in a recombined single-mode beam.

For this purpose, the present disclosure proposes a device for processing at least two single-mode and coherent light beams, called “incident beams,” the incident beams having variable phases and amplitudes, the processing device comprising at least, connected to each other in succession by free spaces or by waveguides according to a main direction of propagation:
a first phase actuator circuit for adjusting the relative phases of the incident beams;
a multi-plane conversion device for receiving, on a first optical port, the light beams coming from the first phase actuator circuit and configured to distribute the energy of these beams to at least two single-mode light beams, called “converted beams,” produced at a second optical port; and
a second phase actuator circuit arranged downstream of the multi-plane conversion device in order to adjust the relative phases of the converted beams (I′).

According to other advantageous non-limiting features of the present disclosure, taken alone or according to any technically feasible combination:
the converted beams at the output of the second phase actuator have relative amplitudes and relative phases in accordance with relative setpoint amplitudes and to relative setpoint phases;
the multi-plane conversion device comprises a plurality of microstructured zones arranged on at least one optical element to spatially intercept and modify the respective phases of the incident beams during a plurality of reflections or transmissions separated by free propagation;
the first phase actuator circuit and the second phase actuator circuit comprise a plurality of optical phase shifters associated with the incident beams and the processing device comprises at least one control device for generating control signals of the optical phase shifters;

According to another aspect, the object of the present disclosure proposes an optical system comprising a processing device as presented above and a spatial demultiplexer, arranged upstream of the first phase actuator circuit, the spatial demultiplexer receiving incident multi-mode light radiation and producing the incident beams.

According to other advantageous non-limiting features of this aspect of the present disclosure, taken alone or according to any technically feasible combination:
the spatial demultiplexer is implemented by a multi-plane conversion device;
the converted beams are arranged in a tiled aperture configuration, the juxtaposition of the converted beams producing a single-mode recombined light beam;
the system comprises a spatial multiplexing device arranged downstream of the second phase actuator circuit, the spatial multiplexing device receiving the converted beams in order to recombine them in a single mode recombined light beam;
the spatial multiplexing device is implemented by a multi-plane conversion device;
the optical system comprises a reflective optical part arranged directly downstream of the second phase actuator circuit to backpropagate the converted beams through the second phase actuator circuit and the multi-plane conversion device and to provide the single-mode recombined light beam at the first optical port of the multi-plane conversion device;
the optical system comprises a device for extracting the single-mode recombined light beam, the extraction device being arranged between the first phase actuator circuit and the multi-plane conversion device;
the recombined single-mode light beam is formed only at a reserved mode of the first optical port of the multi-plane conversion device;
the processing device is coupled to a single-mode optical fiber into which the recombined single-mode light beam is injected;
the optical system comprises an optical receiver for receiving the single-mode recombined light beam;
the optical receiver comprises an optical amplifier of the recombined single-mode light beam, a spectral demultiplexer and/or a coherent or direct detection device;
the optical system comprises an optical emitter for producing at least one single-mode emission light beam, called “emission beam,” the optical system emitting pre-compensated radiation in a direction opposite to that of the incident multimode radiation;
the optical system comprises an emission subsystem, a receiving subsystem, the emission subsystem being configured from parameters determined in the receiving subsystem;
the optical receiver and the optical emitter are coupled to the processing device or to the spatial multiplexing device via an optical circulator;
the optical emitter produces a plurality of emission beams and is arranged to counter-propagate at least part of each emission beam in a direction opposite to the main direction of propagation in the processing device;
the optical system comprises a separator device according to the wavelength or according to the polarization, such as a mirror or a dichroic filter;
the optical system comprises a light source, arranged upstream of the spatial demultiplexer and producing incident multimode light radiation;
the optical system comprises a shaping device arranged downstream of the second phase actuator circuit, the shaping device receiving the converted beams to produce a shaped light beam;
the setpoint relative phases and relative amplitudes are chosen to give a predetermined shape to the shaped light beam.

### BRIEF DESCRIPTION OF THE DRAWINGS

Other features and advantages of the present disclosure will become apparent from the following detailed description of example embodiments of the present disclosure with reference to the appended figures, in which:

FIG. 1 shows a first embodiment of a processing device according to the present disclosure;

FIG. 2 shows a phase actuator circuit;

FIG. 3 shows the design of a Walsh mode family;

FIGS. 4A-4C show variants of a processing device;

FIGS. 5A and 5B show an optical system for recombining beams;

FIGS. 6A and 6B represent two clever configurations of an optical system for recombining beams;

FIG. 7 shows an exemplary application of the optical system for the compensation of the wavefront;

FIG. 8 shows an optical system for the compensation of the wavefront;

FIGS. 9A-9D represent optical systems making it possible to emit pre-compensated light radiation; and

FIG. 10 shows an optical system used for shaping a beam and the change in shape of a beam.

### DETAILED DESCRIPTION

### Definitions

For the sake of clarity, in the present disclosure, a “light beam” is defined as radiation formed from at least one mode of the electromagnetic field, each mode forming a spatio-frequential distribution of the amplitude, phase, and polarization of the field.

The “shape” of a beam means the transverse distribution of the amplitude and the phase of the mode or the combination of the transverse amplitude and phase distributions of the modes making up this radiation.

“Relative phases” of a plurality of single-mode beams will be understood to mean the phase differences existing between each beam of the plurality and a beam chosen as reference beam.

### General Principles

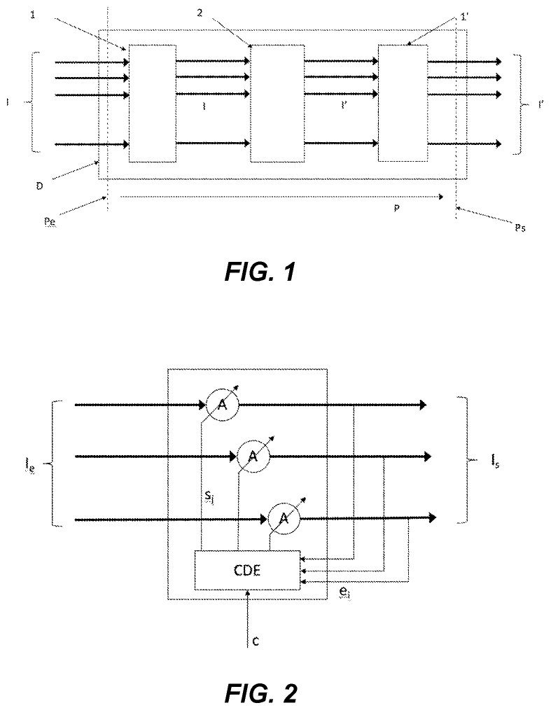

FIG. 1 shows the principles implemented in a processing device D in accordance with several embodiments. The device D receives at the input at least two single-mode and coherent light beams I. These beams I are spatially separated, that is to say that their shapes do not intersect or intersect little at an input plane Pe of the device D. The device D produces at the output at least two output light beams I′ (also denoted “converted beams”), also spatially separated, the amplitudes and the phases of which are regularized. The number of incident light beams I and the number of output light beams I′ of the device are identical. The number of beams I, I′ can be chosen very freely, depending on the need. It is typically between 2 and 50, or between 2 and 100, or even more.

Several examples will be seen in a subsequent section of this disclosure, in which such incident, single-mode and coherent beams can be produced. However, in general, it may be a multimode light radiation whose modes or a plurality of single-mode beams from synchronized sources will have been spatially separated. In every case, the incident light beams I are likely to fluctuate over time, in amplitude and in phase, independently of one another, even though it is possible, at a specified time, for at least some of these incident beams I to have the same phases and amplitudes.

The incident beams I can be spatially freely distributed in the input plane Pe of the device, for example, along a line as in the schematic illustration of FIG. 1, or arranged in a matrix or hexagon. This arrangement can be provided by a network of fibers forming an input stage of the device D (not shown in FIG. 1) when the propagation of the incident light beams I, upstream and/or downstream of the input plane Pe, is guided. But the propagation of the incident light beams I can also be done in free space, and it is then possible to provide optical parts (mirrors, prisms, etc.) to ensure the arrangement of the beams between them according to the chosen arrangement in the input plane Pe. The same comments apply to the output light beams I′ and their relative positioning in an output plane Ps. In this respect, provision may be made to provide the device D with an output stage, for example, in the form of an array of optical fibers.

In the schematic diagram of FIG. 1, a main direction of propagation P of the incident beams I in the device D is shown. This propagation is rectilinear here, but this in no way forms a limitation, and it would be possible for the beams to propagate in the device D according to a more complex optical path, defined by waveguides connecting the various optical circuits of the device and/or by optical parts when this propagation is carried out at least partly in free space.

In general, the processing device D seeks to regularize the amplitude and the phase of the incident beams I. By “regularize,” it is meant that the converted beams I′ have relative phases and amplitudes that do not fluctuate over time relative to one another, or in any case in a much lower proportion than the fluctuations affecting the relative phases and the amplitudes of the incident light beams I. In general, it is sought that the relative phases of the converted beams I′ be combined with setpoint phases, and that in turn the amplitudes of the beams be formed at given relative setpoint amplitudes. For example, in some cases, the device D can be configured so that the converted beams I′ have zero relative phases and amplitudes all equal to one another. But this choice is in no way imperative, and the device D can be configured and controlled by a large variety of setpoints of relative phases and relative amplitudes of the output light beams I′. The relative phase and relative amplitude setpoints can also be modified over time, depending on the need for the application and/or a user. It is of course possible that the phases and amplitudes of the converted beams I′ fluctuate over time (in particular, when the combined energy of the incident beams I varies), but these fluctuations of the parameters of the converted beams I′ are not entirely independent of one another: for example, the respective amplitudes of the converted beams I′ can fluctuate, but these fluctuations are substantially the same for each of the beams. Also, once the regulation is implemented by the properly locked processing device D, the converted beams I′ are much more stable over time than the incident beams I, i.e., the dispersion of their respective parameters (relative phases and relative amplitudes) is much smaller.

To perform this regularization processing, the device D that is the subject of the present description comprises at least:
a first phase actuator optical circuit 1;
an optical multi-plane conversion device 2 (referred to as “MPLC device” in the rest of this description);
a second phase actuator optical circuit 1′.

These three elements are arranged in succession in the main direction of propagation P, that is to say that the MPLC device 2 is arranged optically downstream of the first phase actuator circuit 1, and that the second phase actuator optical circuit 1′ is arranged optically downstream of the MPLC device 2. These elements are interconnected by free spaces or by waveguides allowing the propagation of the light beams. Advantageously, and to maintain its simplicity, the processing device D does not provide, directly downstream or directly upstream of the MPLC device 2, circuits capable of substantially modifying the phase or amplitude of the beams other than those listed above.

In order to simplify the expression, “incident beams” will be understood to mean the beams incident to the processing device D and those propagating up to a first optical port of the MPLC device 2. “Converted beams” will be understood to mean those produced by the MPLC device 2 at a second optical port and propagating downstream of this device 2 and at the output of the processing device D.

In some embodiments, the function of the MPLC device 2 is to regularize the amplitude of the incident beam I. To do so, it is important to properly control the relative phases of the light beams entering this circuit. To this end, the processing device D provides the first phase actuator optical circuit 1, arranged directly upstream of the MPLC device 2.

The transformations carried out by the MPLC device 2 on the amplitude of the incident beams I to regularize them, however, affect the relative phases of the converted beams I′. Also, the processing device D provides a second phase actuator optical circuit 1′, directly downstream of the MPLC device 2, so that the converted beams I′, once processed by this second circuit 1′, have both well controlled relative amplitudes and relative phases.

More generally, the phase actuator optical circuits 1, 1′ form variables for adjusting the beams propagating in the processing device D, so the beams can therefore be modified at any time according to the desired application objective.

FIG. 2 shows, by way of illustration, a phase actuator circuit that can be used as first and/or second circuit 1, 1′ of the processing device D of FIG. 1.

This circuit comprises a plurality of optical phase shifters A respectively associated with input light beams I_{c} of the circuit. Each optical phase shifter A provides a replica Iₛ of the input light beam associated therewith, adjusted in phase with a controllable value, but whose amplitude remains substantially unmodified. An optical phase shifter A can be implemented by a phase shifter or a delay line. It may thus be a continuously deformable mirror, or a deformable segmented mirror, a spatial light modulator, an electro-optical phase modulator, a fiber stretched by a piezoelectric module, a mirror on a piezoelectric shim, or any other suitable means.

The circuit of FIG. 2 also comprises an electro-optical control circuit CDE. Received as input of this control circuit are quantities e± representative of the light beam(s) that it is sought to regulate, and it generates control signals Sⱼ of the optical phase shifters A aimed at controlling the phase adjustment value. The control circuit CDE can also receive a setpoint quantity c (or a vector of quantities) defining the quantities targeted for the parameters of the light beam(s) that it is sought to regulate. These representative quantities may correspond to phase or intensity information of the light beam(s) that it is sought to regulate.

Very generally, the CDE controller implements a regulation method, and produces the control signals Sⱼ from the optical phase shifters A so that the light beam(s) that it is sought to regulate indeed have parameters equal or close to equal to the setpoint quantity.

By way of illustration, and as is reproduced in the example of FIG. 2, the inputs e± of the control device CDE may correspond to a collection of the light beams Is produced directly by the circuit. The control circuit CDE can then determine the relative phases of these beams, for example, by making them interfere with one another. In this case, it is possible to configure the control device CDE to produce the control signals Sⱼ to adjust the phase shift introduced by each optical phase shifter A so that the relative phases of the light beams produced at the output of the Iₛ phase actuator circuit correspond to relative setpoint phases c, for example, so that these relative phases are zero.

It is not necessary for the inputs et of the device to correspond precisely to quantities representative of the light beams Is products at the output of the actuator circuit. The inputs eᵢ may correspond to quantities representative of one or a plurality of light beams generated further downstream.

By way of illustration, the regulation implemented by the control device CDE may seek to optimize a residual energy between a target beam (or a plurality of target beams), that is, a beam having the setpoint phase and amplitude characteristics, and the beam actually produced (or the beams actually produced). This optimization can be based on a gradient method, on a stochastic method, on an interpolator configured by learning, for example, a neural network, on an interpolator configured by fuzzy logic, or more conventional methods of regulation, for example, Kalman, adaptive or robust.

When a processing device uses several phase actuator circuits, as is the case of a processing device D in accordance with the embodiments described in the present disclosure, a single control device CDE can be shared to control the optical phase shifters A used in the formation of each of these circuits.

The MPLC device 2 of the processing device D has a first optical port for receiving the incident light beams I from the first phase actuator circuit 1. It also has a second optical port from which light beams I′, called “converted,” propagate, produced by the MPLC device 2.

For the sake of completeness, it is recalled that in such an MPLC device, incident light radiation undergoes a succession of reflections and/or transmissions, each reflection and/or transmission being followed by free-space propagation of the radiation. At least some of the optical parts on which the reflections and/or the transmissions take place, and which guide the propagation of the incident radiation, have microstructured zones, which modify the incident light radiation.

The term “microstructured zone” means that the surface of the optical part has on this zone a relief, which can, for example, be broken down in the form of “pixels” whose dimensions may be between a few microns and a few hundred microns. It may be metasurfaces. The relief or each pixel of this relief has a variable elevation with respect to a mean plane defining the surface in question, of at most a few microns or at most a few hundreds of microns. Regardless of the nature of the microstructuring of the zones, an optical piece having such zones forms a phase mask introducing a local phase shift within the transverse section of the beam that is reflected there or transmitted there.

Thus, a light radiation that propagates within an MPLC device undergoes a succession of local phase shifts separated by propagations. The succession of these elementary transformations (for example, at least four successive transformations such as 8, 10, 12, 14, or even at least 20 transformations, for example) establishes an overall transformation of the spatial profile of the incident radiation. It is thus possible to configure the microstructured reflection or transmission surfaces to transform a first light radiation, which, in particular, has a specific shape, into a second radiation whose shape is different.

The documents “Programmable unitary spatial mode manipulation,” Morizur et Al., J. Opt. Soc. Am. A/Vol. 27, No. 11/November 2010; N. Fontaine et Al., (ECOC, 2017), “Design of High Order Mode-Multiplexers using Multiplane Light Conversion”; U.S. Pat. No. 9,250,454 and US2017010463 contain the theoretical foundations and examples of practical implementation of an MPLC device.

The MPLC device 2 of the processing device D is configured to distribute the energy of the incident beams I received on the first optical port between the converted beams I′, which propagate from the second optical port. This distribution aims to regularize the amplitude of the converted beams I′. As has already been specified, this distribution is not necessarily equal, even if such an equal distribution of the energy between the converted beams I′ forms a possibility.

As shown in detail in the aforementioned documents, the microstructured zones carried by the optical component(s) forming the MPLC device 2 are designed and configured to operate modal conversion aimed at decomposing the light radiation received on the first optical port (this radiation consisting, in combination, of the incident beams I) in a family of modes called “input.” The energies present in the modes of the input family are transported and respectively shaped to modes of a family of “output” modes at the second optical port. The MPLC device is configured to respectively match the input base modes and the output base modes. It is a passive device, whose transfer function is particularly stable and robust.

In the case of the processing device D of FIG. 1, each mode of the input family is associated with a single light beam received on the first optical port. Simultaneously, each mode of the output family is associated with the plurality of converted beams I′, at the second optical port. The energy of a beam, and more precisely the part of energy of the beam, which projects in the mode of the input base to which it is associated, is therefore distributed in one of the modes of the output base, and therefore in the plurality of output beams.

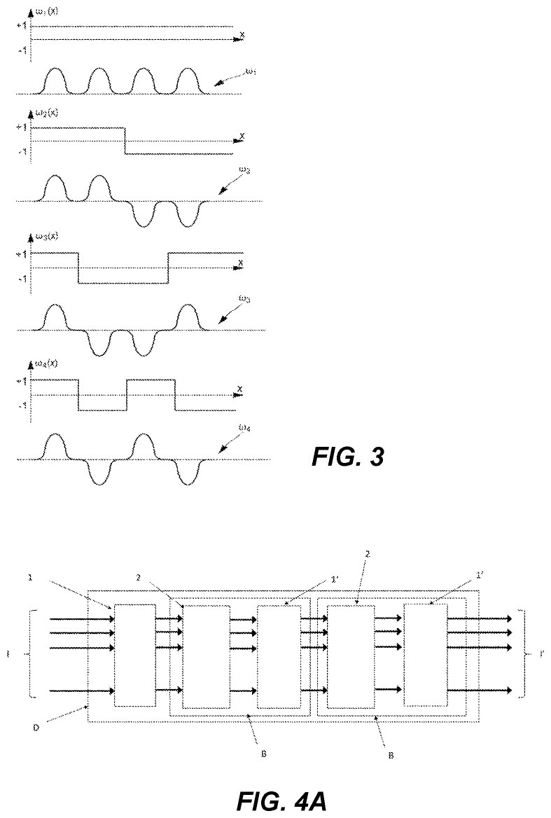

By way of example of configuration of the MPLC device 2, the family of input modes may comprise a base of N separate Gaussian modes, each mode of the base being spatially mapped to one of the N light beams received on the first optical port. The family of output modes may be formed by N Walsh modes. It will be recalled that the Walsh modes are modes comprising several distinct lobes, for example, Gaussian lobes. A Walsh mode family can be constructed from a base distribution respectively multiplied by the Walsh function Wₖ(x), for k=1, 2 . . . . N, as shown in FIG. 3 in the case of a family composed of four modes W1, W2, W3, W4 (in one dimension in this figure, it being understood that in the context of the application these modes extend spatially). In the representation of FIG. 3, the N lobes of the base distribution are Gaussian and of identical amplitudes, but this is not necessarily the case.

The MPLC device 2 is configured to associate a Gaussian mode of the input base to a Walsh mode of the output base. The energy of a beam received on the first optical port (in correspondence with one of the modes of the input base) is transported in the MPLC device to conform to the Walsh mode with which this mode of the input base is associated. This energy is therefore distributed in each of the lobes of this mode. When all the incident beams I received on the first input port are taken into account, it is understood that the light radiation at the second optical port has N lobes in which all the energy of the incident beams is concentrated and distributed. The converted light beams correspond to the lobes of this radiation.

Of course, the Gaussian and Walsh modes taken as an example are only given by way of illustration. It would be possible to choose other modes than those of Gauss to form the family of input modes and other modes than those of Walsh to constitute the family of output modes. It may thus be a collection of output modes corresponding to the discrete Fourier transform of the input modes. Thus, for the j^{th} input mode (from N input modes), the associated output mode, corresponding to a converted beam I′, may consist of N lobes, for example, Gaussian lobes, for which the phase of the k^{th} lobe is equal to:

$${ϕ}_{j , k} = \frac{2 π jk}{N} \text{?}$$

$$\text{?} \text{indicates text missing or illegible when filed}$$

According to a particularly advantageous embodiment, each mode of the family of output modes comprises a plurality of lobes (as is the case in the example shown in FIG. 3), but these lobes are not purely Gaussian shapes: they consist of a main lobe (which can be Gaussian) and of a secondary lobe of smaller size and of smaller amplitude. These secondary lobes are not intended to collect a lot of energy, but can serve to produce the inputs eᵢ of the control devices CDE, for example, that of the first and/or of the second phase actuator circuit 1, 1′. By producing secondary beams by the MPLC 2 (in correspondence with the secondary lobes of the modes of the family of output modes), sampling in the converted beams the part of energy necessary for implementing the phase regulation and the insertion of an optical part to carry out this sampling is avoided.

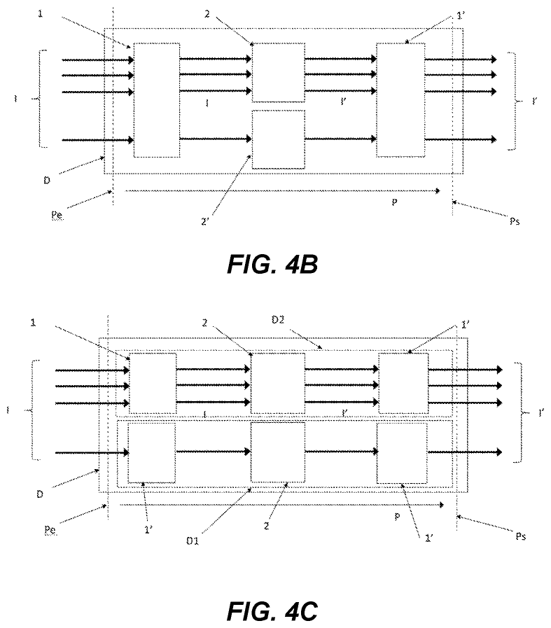

It is possible to supplement the processing device D of FIG. 1, downstream of the second phase actuator optical circuit 1′, of at least one block B consisting of another MPLC device 2 optically coupled to another phase actuator optical circuit 1′. The processing device D, generally, can therefore consist of a concatenation of a number M of such blocks B, downstream of the first phase actuator circuit 1, and can therefore comprise, in an interleaved manner, M+1 phase activating circuits l′ and M MPLC device 2. It is thus possible, by breaking down the optical processing applied to the incident beams I into several stages, each implemented by a block B−, to better control the optical transformations carried out by simplifying the operations carried out in each stage. Such a multi-stage configuration is shown in FIG. 4A.

Alternatively or in addition to this variant, provision may be made for the processing device D to comprise a second MPLC device 2′, in parallel with the first MPLC device 2, as shown in FIG. 4B. Only part of the incident beams I apply to the input of the first MPLC device 2, the complementary incident beams applying to the second MPLC device 2′. This configuration can be particularly useful when the number of incident beams is large, for example, of the order of 100 or more, in order to simplify the design of the MPLC devices 2, 2′.

Finally, provision may be made for the processing device D to comprise two processing devices D1, D2, each of these devices being in accordance with the general description that has just been provided of such a processing device. Such a configuration is shown in FIG. 4C.

### Optical Beam Recombination System

A possible application of the processing device D that has just been presented is that of recombining the incident beams I in at least one recombined single-mode light beam I″, called “recombined beam.”

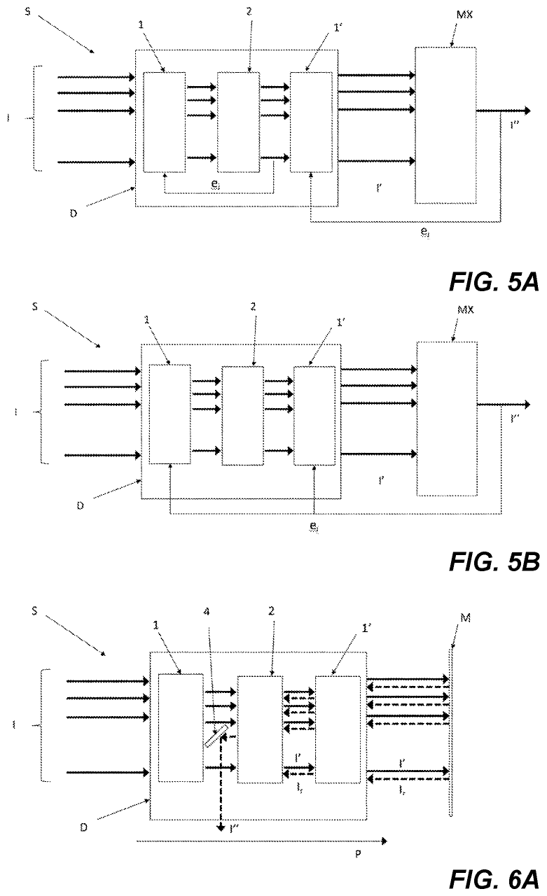

In this application, shown in FIGS. 5A and 5B, an optical system S is formed by arranging, downstream of the processing device D, directly behind the last phase actuator circuit 1, a spatial multiplexing device MX. This spatial multiplexing device MX (which could also be referred to as “optical mixer” or “combination device”) receives as input the converted beams I′ to recombine them together in at least one recombined beam I″. It should be noted that it is possible for the spatial multiplexing device MX to have several outputs, and therefore that it recombines the converted beams I′ into several recombined beams I″. The recombined beam or beams I″ by the spatial multiplexing device MX then concentrate all the energy of the incident beams I.

The spatial multiplexing device MX can be made in any suitable form, for example, by means of an MPLC device, configured like the one described in document WO2020161126, by a photonic lantern, freeform optics, a spatial light modulator, diffractive optical elements, an interferometric system, a Dammann network, etc. The spatial multiplexing device MX, regardless of its implementation, can take a photonic integrated form or a discrete optical component form.

According to a particularly interesting variant, the converted beams I′ do not require a spatial multiplexing device MX to be recombined and to form the recombined beam I″. According to this variant, at the output of the processing device D, the converted beams I′ are arranged close to one another, in a tiled aperture configuration. Such an arrangement can be produced by the MPLC 2 if it was designed to produce such a result. In this configuration, the recombined beam I″ can be very simply formed by the simple juxtaposition of the converted beams I′, and the spatial multiplexing device MX can be substituted, optionally, by simple collimation lenses arranged opposite each converted beam I′ in order to constitute the recombined beam I″.

In the illustration of FIG. 5A, the inputs eᵢ of the control devices of the first and of the second phase actuator circuit 1, 1′, correspond, respectively, to the converted beams provided by the MPLC device, and to the recombined beam I″. In the illustration of FIG. 5B, the inputs et of the control devices of the first and of the second phase actuator circuit 1, are only formed from the recombined beam I″. As has already been mentioned, provision could be made to share a single control circuit CDE for the two phase actuator circuits 1, 1′.

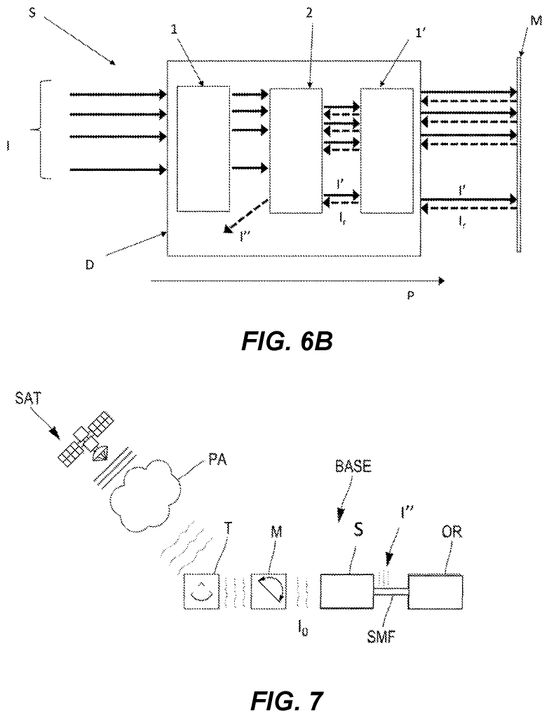

FIG. 6A shows a clever configuration of an optical system S implementing a processing device D for this recombination application. This configuration results from the fact that the MPLC device 2 of the processing device (or the most downstream of these devices if several are present) itself performs a demultiplexing operation: the energy supplied by an incident beam I on the first optical port of the MPLC device 2 is distributed over all the converted beams I′ of the second port of this device. Such an MPLC device being reversible, it performs a multiplexing operation identical to the one implemented by the spatial multiplexing device MX when the light beams propagate in the direction opposite to the main direction P, therefore from the second optical port to the first optical port.

This observation results in the advantageous arrangement of the system S shown in FIG. 6A. In this arrangement, a reflective optical part M is available, for example, a mirror, downstream of the processing device D. The converted beams I′ are reflected on this reflective optical part M, and the reflected beams Iᵣ, in dashed lines in FIG. 6A, propagate in the processing device D in the direction opposite to the main direction of propagation P. In doing so, the reflected beams Iᵣ successively propagate in the second phase actuator circuit 1′ then in the MPLC device 2, via the second optical port. The latter recombines these light beams Iᵣ to form a recombined beam I′, made available on the first optical port of the MPLC device 2. To simplify FIG. 6A, not shown in this figure are the inputs e± of the phase actuator circuits 1, 1′, but they are of course present.

An extraction device 4 can be provided, for example, an optical circulator, of the recombined light beam I″, the extraction device 4 being arranged between the first phase actuator circuit 1 and the multi-plane conversion device 2 so as to redirect the recombined light beam and extract it from the processing device D, before it propagates in the first phase actuator circuit 1. In the configuration of FIG. 6A, the setpoint values of the processing device D, in phases and in amplitudes, are chosen so that the reflected beams Ir, propagating through the MPLC device 2, recombine in a recombined beam I″ (or a plurality of recombined beams I″) in correspondence with at least one mode of the input base of this device 2.

In a variant of this configuration shown in FIG. 6B, provision may be made to design the MPLC with a family of input and output modes each having N+1 modes, N corresponding to the number of incident radiations received on the first optical port of the MPLC device 2. One mode of the input family is reserved, that is, none of the incident beams I is mapped, in the input plane Pe of the MPLC device 2, with this reserved mode.

At the same time, the MPLC device 2 can be configured so that the illumination of this reserved mode produces converted beams I′ having characteristics of relative phases and of determined amplitudes. These characteristics form the relative phase and amplitude setpoints of the processing device D, which apply to the reflected radiation Ir at the output of the second phase actuator circuit 1′. When the regulation implemented by the control device(s) CDE is properly locked on these relative phase and amplitude setpoints, the reflected radiation Ir is recombined by the device MPLC in a combined radiation I″ generated on the first optical port only at the reserved mode of the family of input modes. In this way, placing a complex extraction device in the processing device, as is the case in the configuration of FIG. 6A, is avoided.

It should be noted that in the optical system of FIGS. 6A and 6B, the second phase actuator circuit 1′ is crossed a first time by the converted beam I′ then by the reflection of this beam, and that therefore the phase shifts imparted to the beams is twice what is imposed by the optical phase shifters A. This may naturally be taken into account in the regulation implemented by the control device CDE of these circuits. In the configurations of FIGS. 6A and 6B the MPLC device 2 constitutes the spatial multiplexing device MX making it possible to recombine the converted light beams I′.

Application of the optical recombination system to compensate for the distortion of a light radiation

Referring to FIG. 7, an example of use of the optical recombination system S in the field of telecommunications for compensating for the distortion of a wavefront is presented.

In this purely illustrative example, an emitter SAT-here a communication satellite-emits a light beam for transmitting a message toward a base station BASE in a completely conventional manner. The light radiation may have several wavelengths, as is usually the case for WDM type transmissions. The light radiation directly emitted by the satellite SAT has a regular shape. During its propagation in free space, the radiation emitted is subjected to atmospheric disturbances of the atmosphere PA, so that the light radiation arriving at the base station BASE has amplitude and phase aberrations. This phenomenon affects the shape of this radiation, which takes a variable shape over time, erratically and irregularly. Consequently, this radiation is injected with little efficiency and in a variable way over time, in a single-mode optical fiber necessary for the optical amplification of the signal and its coherent detection.

Despite this phenomenon, it is sought to use in the base station BASE the radiation received via an optical receiver OR in order to decode the transmitted message by direct or coherent detection. To this end, a telescope T is provided to collect part of the light beam received with the optional assistance of other optical elements such as an orientable mirror M. The radiation received (and more precisely the part of this radiation collected by the telescope T) is directed toward the optical system S used here for compensating for the distortion of light radiation f I₀. The latter seeks at least partially to compensate for this distortion in order to provide a recombined single-mode light beam I″ whose distortion is less than that of the radiation received I₀. The recombined single-mode light beam I″ is then coupled with more efficiency and stability in a single-mode fiber SMF, which makes it possible to guide this beam toward the optical receiver OR.

In this exemplary application, the energy of the radiation received at the telescope T is generally very low, in particular, because the power of the emitter on board the satellite SAT is limited, and because of the errors of pointing, deformation, and expansion of the emitted light beam during its propagation in free space. It is therefore important, for transmission bandwidth reasons, that the optical system S transmits a maximum of the collected energy to the receiver OR.

FIG. 8 shows the optical system S used to compensate for the distortion of a wavefront shown in FIG. 7. In this system S, the processing device D and the spatial multiplexing device MX are recognized. It should be noted that any of the optical systems S presented in relation to the description of FIGS. 5A, 5B, 6A, and 6B could be suitable in this particular application. The optical system of FIG. 8 further comprises a spatial demultiplexer DX, arranged upstream of the first phase actuator circuit 1, the spatial demultiplexer DX receiving incident multi-mode light radiation Iₒ and producing the incident beams I. Once again, this demultiplexer DX can take any suitable form, an MPLC device, a photonic lantern, etc.

The optical system S therefore receives the incident multimode light radiation I₀, which it breaks down into the plurality of incident beams I. These single mode beams I, whose characteristics (amplitudes and phases) are highly variable because of the amplitude and phase aberrations of the incident radiation I₀ received, project into the processing device D. This regularizes these incident beams I, as was presented in an initial section of this description, by adjusting the optical phase shifters A of the phase actuator circuits 1, 1′. The converted and therefore regularized beams I′, are recombined by the spatial multiplexing device MX to form the recombined single-mode light beam I″. The latter can be injected into the single-mode fiber SMF making it possible to guide it to the receiver OR at the end of analysis and/or decoding of the transmitted message. Provision may be made for the receiver OR to integrate amplification functions of the recombined light beam I″, of spectral demultiplexing, in particular, in the context of a WDM transmission, and coherent or direct detection.

It will be noted that the proposed solution is particularly original, insofar as it does not require the incident multimode light radiation I₀ to be processed by an adaptive optical device as is often the case in the solutions of the prior art aimed at compensating for the distortion of a wavefront of a light radiation.

The phase shifts imparted by the optical phase shifters A of the phase actuator circuits 1, 1′ when the regulation implemented by the control device(s) CDE is indeed locked, in some way form a signature of the disturbances undergone by the incident multimode radiation I₀ during its propagation.

In an improved version of the optical system S that has just been presented, advantage is taken of the locking of this regulation to use this optical system S, or a Siamese optical system, in emission. In this emission mode, a “pre-compensated” emission radiation, that is to say, deformed in such a way that when this radiation reaches its target (here the emitter SAT, which emits the light radiation of original transmission), this radiation has a reduced deformation of its wavefront. This pre-compensation is precisely the one defined by the phase shifts imparted by the optical phase shifters A of the phase actuator circuits 1, 1′.

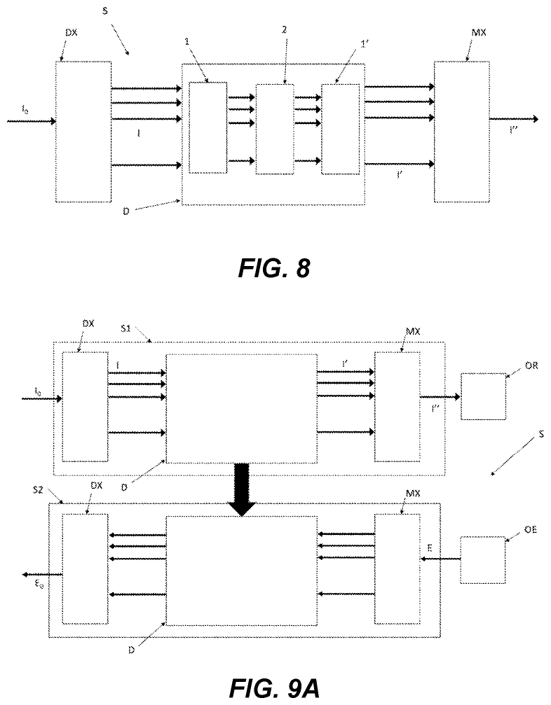

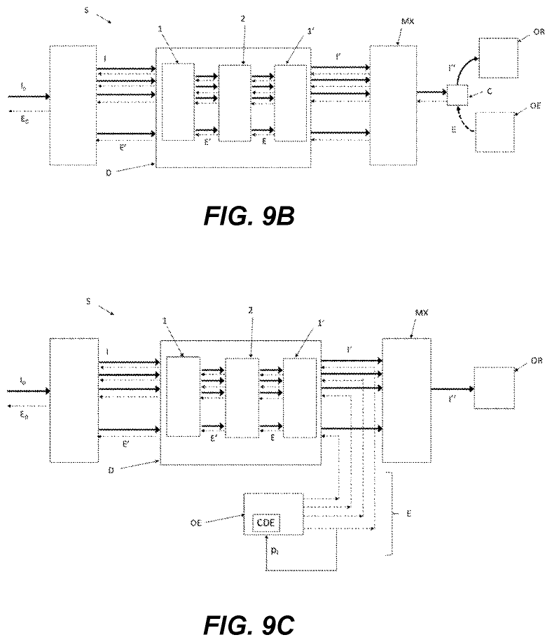

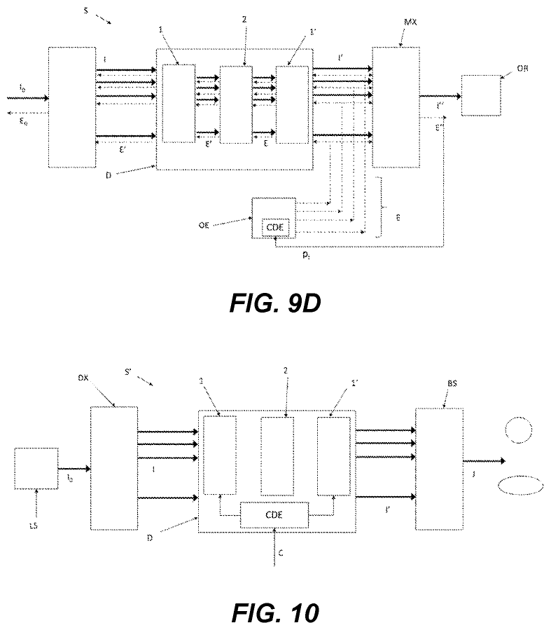

FIGS. 9A-9C of the optical systems S are configured to implement such emission of a precompensated radiation.

The optical system S of FIG. 9A is composed of two perfectly identical Siamese subsystems S1, S2. The first subsystem S1 is a receiving subsystem, as described above in the different configurations disclosed. It is composed of a demultiplexer DX, a processing system D and a spatial multiplexing device MX. It therefore receives an incident multimode light radiation I₀ and supplies a recombined light beam I″. This transformation leads the control device(s) CDE to establish, for determined durations, the values of the phase shifts applied to the optical phase shifters A of the phase actuator circuits 1, 1′. As has been mentioned, these phase shift values “sign” the nature of the disturbances undergone by the incident multimode radiation I₀ during its propagation.

The second subsystem S2 is an emission subsystem. This subsystem S2 includes the same demultiplexer DX, processing system D, spatial multiplexing device MX as in the subsystem S1. In addition, the subsystem S2 is associated with an optical emitter OE, for example, a telecom emitter producing amplitude or phase modulated radiation by direct or coherent modulation. This emitter OE emits a single-mode beam E, which propagates successively in the spatial multiplexing device MX, the processing system D and the demultiplexer DX, in order to emit an emission radiation E0 in a direction opposite that of the incident radiation I₀. In order to compensate for the phase and amplitude distortions that this radiation E0 will undergo during its propagation, it is provided to configure the emission subsystem S2 by applying to the optical phase shifters A of its phase actuator circuits the same values as those determined by the control device CDE of the first reception subsystem S1, or values derived therefrom. In other words, the emission subsystem S2 is configured from parameters determined in the reception subsystem S1. These parameters may correspond to the values of the phase shifts applied to the optical phase shifters A of the phase actuator circuits 1, 1′ of the reception subsystem S1, or to parameters related to these values. In this way, the two subsystems S1, S2 are perfectly Siamese, and the emission radiation E0 is pre-compensated from the distortion information collected in the reception subsystem S1.

In the optical system S of FIG. 9B, a single processing device is used to simultaneously receive the multimode incident radiation I₀ and to emit the pre-compensated emission beam E. The optical receiver OR and the optical emitter EO are both arranged downstream of the spatial multiplexing device (in the direction of propagation of the recombined radiation I″), and this radiation is propagated in the demultiplexer DX, the processing system D and the spatial multiplexing device MX according to the same optical paths, but in opposite directions. In the assembly shown in FIG. 9B an optical circulator C is provided to direct the recombined beam I″ toward the optical receiver, and to direct the emission radiation to the spatial multiplexing device MX. These propagations can be fiberized.

More generally, and depending on whether or not a spatial multiplexing device MX is included in the optical system S, the optical receiver OR and the optical emitter OE can be coupled to the processing device D or to the spatial multiplexing device MX via an optical circulator C.

In a variant not shown of the system of FIG. 9B, the optical circulator C can be omitted. It is nevertheless possible to use the optical system S in emission as well as in reception, for example, by alternating its operation between either of these two modes. Alternatively, it is possible to choose the emission beam E so that it has a polarization or a wavelength different from a polarization or a wavelength of the incident beams I, and to insert a separator device according to the wavelength or according to the polarization, such as a mirror or a dichroic filter.

In the optical systems S of FIGS. 9C and 9D, the optical emitter OE produces a plurality of single-mode emission beams E. These beams have well controlled relative amplitudes and relative phases, which are therefore stable over time. The emitter OE comprises a master source producing a master light radiation. This may be, for example, a laser source. The master source is connected to an optical splitter to establish a plurality of beams from the master light radiation. To enable the phase control of the light beams produced, the beams are coupled to a phase actuator circuit in accordance with the circuit shown in FIG. 2. The optical emitter OE LS may also provide an optical amplification stage associated with each beam in order to provide usable emission light beams E. And as has already been indicated, the optical emitter OE may comprise an amplitude and/or phase modulator of each beam.

In the optical systems S configured for emission-reception of FIGS. 9C and 9D, the optical emitter OE is arranged to counter-propagate at least part of each emission beam E in a direction opposite the main direction of propagation P in the processing device D. The emission beams E advantageously have a polarization or a wavelength different from a polarization or a wavelength of the incident beams I.

The emission beams E therefore propagate in this processing device D and therefore undergo transformations inverse to those applied to the incident light beam I. Just as in the two preceding examples, the processing device D therefore establishes a plurality of converted emission beams E′ that are recombined by the demultiplexer DX to provide the emission radiation E0, pre-compensated.

In the optical system S of FIG. 9C, the inputs p± of the control device CDE of the phase actuator circuit of the optical emitter OE correspond to a collection of the light beams E produced directly by this emitter OE. In the system of FIG. 9D, the emission beams are separated by an optical separator (not shown) and a portion of the emission beams E are also directed toward the spatial multiplexing device MX, for example, by beam splitting mirror or an optical circulator. This portion of the emission beams is therefore recombined in a single-mode beam E″ whose characteristics form the inputs p± of the control device of the phase actuator circuit of the emitter OE. In this figure, the output of the spatial multiplexing device MX is therefore used to control the optical emitter OE.

### Application of the Processing Device D to the Change in Shape of a Beam

FIG. 10 shows an optical system S′ used for shaping a beam and/or changing the shape of a beam. This system may, in particular, be useful in dynamic laser light shaping applications, for example, for laser processing of parts, shaping, cutting, welding, drilling, surface functionalization, thin film ablation, or additive manufacturing. It is known that in these applications it may be useful to modify the shape of the beam that projects onto the part, depending on the nature of this part or the processing to be carried out. It is also known that in these applications the beam that projects onto the part has a particularly significant power, for example, of the order of 100 W up to 20 kW in continuous mode and, in pulse mode, of 10 micro-Joules to a few milli-Joules, or more.

On the system S′ shown in this figure, there is a light source LS producing incident light radiation I₀, separated by the demultiplexer DX into a plurality of single-mode incident beams I. These beams I have relative amplitudes and relative phases that are not perfectly controlled. One of the reasons may result from the fact that, in an industrial environment in which the laser source LS operates, the latter can be subjected to uncontrolled movements such as vibrations. These uncontrolled movements affect the regularity of the incident beams and, in particular, their respective phases.

Also found on this optical system S′ of FIG. 10, downstream of the processing device D, directly behind the last phase actuator circuit 1, is a shaping device BS that here has an output making it possible to provide the formed single-mode beam J, this beam forming the laser processing beam of the parts.

When the converted beams I′ at the input of the shaping device BS are prepared by the processing device D according to a first configuration defined by the relative set point amplitudes and relative phases, the shaping device BS combines these converted beams I′ and carries their energy to form a shaped beam J of substantially round shape. In the same way, when the converted beams I′ at the input of the shaping device BS are prepared by the processing device D according to a second configuration defined by second relative setpoint amplitudes and relative phases, the shaping device BS processes these converted beams I′ and carries their energy to form a shaped beam J of substantially oval shape.

The shaping device BS can advantageously be implemented by an MPLC shaping device, specifically configured to perform this transformation, that is to say transform the converted beams, when these are compliant with the setpoint relative amplitudes and phases of the first configuration, to produce a combined round shape radiation and transform the converted beams, when these are compliant with the setpoint relative amplitudes and phases of the second configuration, to produce combined radiation of oval shape. The shaping device BS may alternatively or additionally comprise free-form optics, diffractive optical elements, etc. The setpoint relative amplitudes and phases constitute in a way a shape setpoint, making it possible to give a predetermined shape to the recombined beam I″, to choose here between a round shape and an oval shape.

Of course, the round and oval shapes of the shaped beam J are given by way of illustration only, and in a more general manner, the shaping circuit BS may be configured to form a shaped beam J that can have various shapes. For example, the family of output modes used for the design of the shaping circuit BS may comprise Hermite-Gauss modes, and specific combinations of these modes can be chosen via the “shape” setpoint C applied to the optical system S′. In this way, the shape of the shaped beam J can be changed, for example, its size, and its defocus.

Thus, in the illustration of FIG. 10, the processing device D in accordance with the general description that was made thereof is found in a previous section of this description. This device therefore here receives a shape setpoint C provided at the input of a control device CDE of the phase actuator circuits 1, 1′. This shape setpoint is interpreted by the control device CDE to selectively conform the converted beams I′ to the first configuration of relative amplitudes and relative phases or to the second configuration of relative amplitudes and relative phases. In other words, when a first shape setpoint C is applied to the processing device D, the latter produces converted beams I′ complying with the first configuration, and when a second shape setpoint C is applied, different from the first, the processing device D produces converted beams I′ complying with the second.

Thus, with the system S′ shown in FIG. 10, it is possible to choose the shape of the power beam J that will apply to the part to be processed, and to modify it continuously by choosing and changing over time the shape setpoint C applied to the processing device D.

Naturally, the present disclosure is not limited to the embodiments described, and it is possible to add alternative embodiments without departing from the scope of the invention as defined by the claims.

1. A processing device for processing at least two single-mode and coherent incident light beams, the incident light beams having phases and/or amplitudes capable of varying, the processing device comprising, connected in succession to each other by free spaces or by waveguides according to a main direction of propagation, at least the following elements:
a first phase actuator circuit configured to adjust relative phases of the incident light beams;
a multi-plane conversion device configured to receive, on a first optical port, light beams coming from the first phase actuator circuit and configured to distribute energy of these light beams to at least two single-mode converted light beams produced at a second optical port; and
a second phase actuator circuit arranged downstream of the multi-plane conversion device and configured to adjust relative phases of the converted light beams.

2. The processing device of claim 1, wherein the converted beams at the output of the second phase actuator have relative amplitudes and relative phases respectively in accordance with relative setpoint amplitudes and to relative setpoint phases.

3. The processing device of claim 1, wherein the multi-plane conversion device comprises a plurality of microstructured zones arranged on at least one optical element to spatially intercept and modify the respective phases of the incident light beams during a plurality of reflections or transmissions separated by free propagation.

4. The processing device of claim 1, wherein the first phase actuator circuit and the second phase actuator circuit comprise a plurality of optical phase shifters associated with the incident light beams and the processing device comprises at least one control device configured to generate control signals of the optical phase shifters.

5. An optical system comprising a processing device according to claim 1 and a spatial demultiplexer, arranged upstream of the first phase actuator circuit, the spatial demultiplexer configured to receive an incident multi-mode light radiation and produce the incident light beams.

6. The optical system of claim 5, wherein the spatial demultiplexer is implemented by a multi-plane conversion device.

7. The optical system of claim 5, wherein the converted light beams are arranged in a tiled aperture configuration, a juxtaposition of the converted light beams producing a recombined single-mode light beam.

8. The optical system of claim 5, further comprising a spatial multiplexing device arranged downstream of the second phase actuator circuit, the spatial multiplexing device configured to receive the converted light beams and to recombine the converted light beams in a recombined single-mode light beam.

9. The optical system of claim 8, wherein the spatial multiplexing device is implemented by a multi-plane conversion device.

10. The optical system of claim 8, further comprising a reflective optical part arranged directly downstream of the second phase actuator circuit to back-propagate the converted light beams through the second phase actuator circuit and the multi-plane conversion device and to provide the single-mode recombined light beam at the first optical port of the multi-plane conversion device.

11. The optical system of claim 10, further comprising a device for extracting the recombined single-mode light beam, the extraction device being arranged between the first phase actuator circuit and the multi-plane conversion device.

12. The optical system of claim 10, wherein the recombined single-mode light beam is formed only at a reserved mode of the first optical port of the multi-plane conversion device.

13. The optical system of claim 7, wherein the processing device is coupled to a single-mode optical fiber into which the recombined single-mode light beam is injected.

14. The optical system of claim 13, further comprising an optical receiver configured to receive the recombined single-mode light beam.

15. The optical system of claim 14, wherein the optical receiver comprises an optical amplifier of the recombined single-mode light beam, a spectral demultiplexer and/or a coherent or direct detection device.

16. The optical system of claim 14, further comprising an optical emitter for producing at least one single-mode emission light beam, the optical system emitting a precompensated radiation in a direction opposite to that of the incident multimode radiation.

17. The optical system of claim 5, further comprising an emission subsystem and a reception subsystem, the emission subsystem being configured from parameters determined in the reception subsystem.

18. The optical system of claim 16, wherein the optical receiver and the optical emitter are coupled to the processing device or to the spatial multiplexing device via an optical circulator.

19. The optical system of claim 16, wherein the optical emitter produces a plurality of emission beams and is arranged to counter propagating at least part of each emission beam in a direction opposite to the main direction of propagation in the processing device.

20. The optical system of claim 11, further comprising a separator device according to the wavelength or according to the polarization.

21. The optical system of claim 5, further comprising a light source, arranged upstream of the spatial demultiplexer, and configured to produce the incident multi-mode light radiation.

22. The optical system of claim 21, further comprising a shaping device arranged downstream of the second phase actuator circuit, the shaping device configured to receive the converted beams and produce a shaped light beam.

23. The optical system of claim 21, wherein the relative phases and the relative target amplitudes can be chosen to give a predetermined shape to the shaped light beam.
